(19) United States
(12) Patent Application Publication
(10) Pub. No.: US 2018/0044020 A1
(43) Pub. Date: Feb. 15, 2018

(54) HOISTING CABLE FOR A HELICOPTER HOIST

(71) Applicant: Reel, Saint Cyr Au Mont D'or (FR)

(72) Inventors: Paul Severy, Salon De Provence (FR); David Figoureux, Salon De Provence (FR)

(21) Appl. No.: 15/556,552

(22) PCT Filed: Mar. 9, 2016
(86) PCT No.: PCT/FR2016/050537

§ 371 Date: Sep. 7, 2017

(30) Foreign Application Priority Data
Mar. 17, 2015 (FR) 1552171

(51) Int. Cl. B64D 1/22; B64D 45/02

(52) U.S. Cl. CPC B64D 1/22; B64D 45/02

(57) ABSTRACT

A hoisting cable for a helicopter hoist includes at least one first electric conductor built into a non-conductive structure, and at least one second electric conductor, electrically isolated from the first conductor along the entire length of the hoisting cable and looped back onto said first conductor, to form an electric circuit closed on a switch.

### TECHNOLOGICAL FIELD

The disclosure relates to the field of hoisting cables intended to be used at the level of hoists embarked in helicopters and, more specifically, to a cable of composite or textile nature, having physical strength properties particularly close to those of conventional steel cables, while being much lighter.

### BACKGROUND

The use of composite or textile cables, that is, which are in principle electrically isolating, generates two types of issues.

The first one relates to the equalization of the electrostatic potential of the helicopter and of the cargo or load to be embarked. It should indeed be reminded that during helicopter flights, particularly in hovering mode, the surface of the aircraft is submitted to the impact of particles of any nature, inducing the creation of an electric charge. Such an electric charge generates a potential difference between the helicopter and the load, be it human (in the case of a rescue) or material likely to be supported by the cable of an embarked hoist, where the potential difference may reach several hundreds of kilovolts. It may thus seriously injure the rescuer or the person to be rescued, or damage the transported cargo.

A solution to overcome this disadvantage is the use of a second conductive cable, intended to connect the helicopter to ground, and only dedicated to suppressing the potential difference thus generated. Such a solution is not satisfactory, due to the obvious risk of seeing this second cable getting caught in one of the two rotors of the helicopter.

This issue is exacerbated when a non-conductive hoisting cable is used. Indeed, while in the context of the use of steel cables, which are electrically conductive, such a potential equalization may occur instantaneously, due to the electric conductivity of steel, that is, the operator places said cable into contact with the ground before tying it up to the load, this is not true when using a non-conductive cable. Indeed, all the static energy stored by the helicopter discharges onto the load when the latter comes into contact with the earth potential, said load being possibly human, causing risks of injury.

To overcome this issue, a conductive composite cable has been described. This cable has the same electrostatic properties as a steel cable. However, the same above-targeted electrostatic discharge issues are still encountered.

Another issue to be overcome with the use of composite or textile cables is the detection of the local wearing of said cables to provide replacing them when necessary. Indeed, in the case of steel cables, the analysis of the cable wearing is made by external observation, of course inducing the total unwinding of said cable but enabling to relatively easily locate possible weaknesses of said cable. However, such an operation generates, due to the need to totally unwind the cable, a significant time consumption, maintenance issues, and such repeated operations induce a premature wearing of the hoist mechanism.

In the case of a textile or composite cable, inner defects of the cable are very difficult to see. Thus, there are no elements capable of informing the user that the cable needs being replaced.

### SUMMARY OF THE DISCLOSURE

The disclosed embodiments are directed to a hoisting cable for a helicopter hoist, said hoist being in electric continuity with the helicopter. The hoisting cable comprises at least one electric conductor built into a non-conductive structure constitutive of said cable.

The cable comprises an electric circuit formed by said at least one first conductor and at least one second electric conductor, electrically isolated from the first conductor along the entire length of the cable, and looped back onto said first conductor, either at the hoist level, or at the level of a hoisting hook arranged at the free end of the hoisting cable, said electric circuit being capable of being closed on a switch, arranged either at the level of said hoisting hook, or at the hoist level.

Thus, the electric circuit thus formed is closed by means of a switch which may be operated by the crew, by the hoist operator, or automatically. This ensures the function of electrostatic continuity between the helicopter and the ground.

According to another feature, the electric circuit is closed on means for measuring an electric quantity, and for example the resistance or the electric resistivity of the circuit. If the measured quantity is smaller or greater than a determined value, this indicates a that at least one of the two electric conductors has broken, thus requiring changing the cable.

Advantageously, the two electric conductors have a breaking strength and a fatigue strength lower than those of the composite or textile structure of the cable incorporating them, for an obvious security purpose.

### BRIEF DESCRIPTION OF THE DRAWINGS

The foregoing features and advantages of the contemplated embodiments will now be discussed in the following non-limiting description of a specific embodiment, in relation with the accompanying drawings.

FIG. 1 is a simplified transverse cross-section representation of the cable.

FIGS. 2a and 2b are simplified representations illustrating the trajectory of the electric conductors within the cable, respectively with the switch arranged at the level of the hoist or of the end hook of the cable of said hoist.

FIG. 3 is a simplified representation similar to FIG. 2a showing a variation.

FIG. 4 is a simplified representation similar to FIG. 2a of another variation.

FIG. 5 is a simplified cross-section representation of the cable of FIG. 4.

### DETAILED DESCRIPTION

A simplified cross-section representation of a cable (1) for a helicopter hoist has thus been shown in FIG. 1. The latter particularly comprises a base (2) made of a composite material or of a textile, which is not electrically conductive. Typically, this base is made of aramid.

In one or more embodiments, two electrically-conductive wires (3), typically made of stainless steel and having a diameter close to 1 millimeter, are built into this structure. These metallic conductive wires (3) of course extend along the entire length of the cable (1).

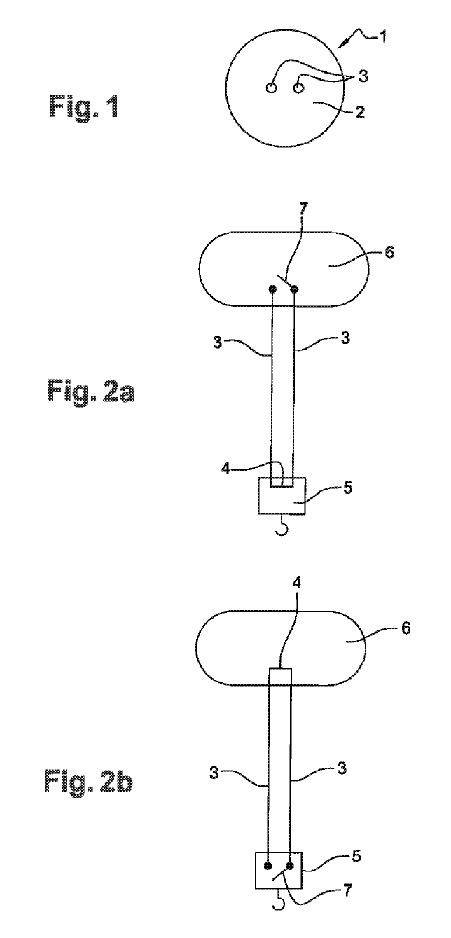

As can be observed in the drawings, the two metal wires (3) are electrically isolated from each other all along the length of the cable (1). However, they are interconnected (4) and thus in electric continuity, at the level of the hoisting hook (5) (FIG. 2a) or at the level of the hoist (6) (FIG. 2b). Thereby, they form an electric circuit, the two other terminals of which will be described hereafter.

Thus, and as shown in FIGS. 2a and 2b, the two other terminals of the electric circuit thus formed are provided within the hoist (6) or the hoist drum forming part of it. Such terminals are capable of being placed in electric contact with each other by means of a switch (7) (FIG. 2a).

As a variation, the electric continuity between the two wires (3) may be achieved within the hoist (6) or the hoist drum and the switch (7) may be arranged within the hoisting hook (5) (FIG. 2b).

In normal operation, that is, when no cargo is hung to the cable, switch (7) is off. In other words, the electric circuit formed by the two electric wires or cables (3) is not closed.

However, during hoisting phases, the switch (7) is operated either by the crew or by the hoist operator, or automatically, to close said circuit. Thereby, the turning-on of the switch (7) generates an equalization of the electrostatic potential of the helicopter and of the cargo hung to the hook (5) or to any equivalent system.

It can thus be understood that the cargo can be protected all along the hoisting against any electric shock by the imposed closing of the circuit when the operational conditions are gathered.

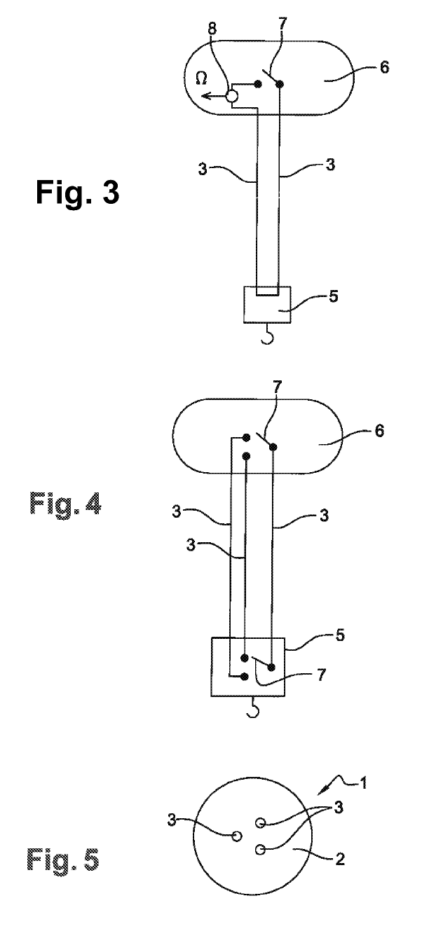

According to an advantageous feature, shown in relation with FIG. 3, the electric circuit formed by the two electric wires or cables (3) closes on a device or member (8) for measuring an electric quantity, in the case in point, the resistance or the resistivity. The measurement member, for example, an ohmmeter, is for example arranged at the hoist level.

It should be understood that as soon as at least one of the electric wires or cables (3) is broken, the resistivity or the resistance drastically increases. A limiting value can thus be set for this quantity, for example, 50Ω for the resistance, beyond which the hoisting cable is deemed non-compliant and has to be replaced.

In order to further guarantee a higher security, electric wires or cables (in terms of constituent material and/or of dimensions) having a breaking strength and a fatigue strength much lower than those of the textile or composite structure (2) incorporating them are used.

According to another variation illustrated in FIGS. 4 and 5, three conductive wires rather than two are used, in a multiway switching assembly well known in the field of electric circuits. In this case, the circuit comprises two switches, respectively arranged at the level of the hoisting hook and of the hoist.

The advantages of the hoisting cable are thus obvious.

First, it enables to protect the cargo, particularly in electrostatic terms during all hoisting phases. The hoist operator is also protected when the cargo is introduced into the helicopter hold.

In parallel, it becomes possible to automatically analyze the integrity of the hoisting cable and thus to prevent its breaking.

1. A hoisting cable for a helicopter hoist, said hoist being in electric continuity with the helicopter, comprising at least one first electric conductor built into a non-conductive structure, wherein the hoisting cable comprises an electric circuit formed by said at least one first conductor and at least one second electric conductor, electrically isolated from the first conductor along the entire length of the hoisting cable, and looped back onto said first conductor, either at the hoist level, or at the level of a hoisting hook arranged at the free end of the hoisting cable, said electric circuit being capable of being closed on a switch arranged either at the level of said hoisting hook, or at the hoist level.

2. The hoisting cable for a helicopter hoist of claim 1, wherein the switch is operated by the helicopter crew, by the hoist operator, or automatically.

3. The hoisting cable for a helicopter hoist of claim 1, wherein the electric circuit is closed on an electric quantity measurement member.

4. The hoisting cable for a helicopter hoist of claim 3, wherein the measured electric quantity is the resistance or the resistivity.

5. The hoisting cable for a helicopter hoist of claim 1, wherein it comprises a third electric conductor, the electric circuit thus formed being assembled in multiway switching assembly between two switches arranged within the hoist and the hoisting hook.

6. The hoisting cable for a helicopter hoist of claim 1, wherein the electric conductors have a breaking strength and a fatigue strength lower than those of the composite or textile structure of the hoisting cable incorporating them
